(19) United States
(12) Patent Application Publication
(10) Pub. No.: US 2011/0257941 A1
(43) Pub. Date: Oct. 20, 2011

(54) SYSTEM AND AUTOMATED METHOD FOR CREATING DRAWINGS ONLINE FOR PRODUCT MANUFACTURING

(76) Inventors: Sebastian Magro, East Setauket, NY (US); Balamurugan Balakreshnan, East Setauket, NY (US)

(21) Appl. No.: 13/089,959

(22) Filed: Apr. 19, 2011

Related U.S. Application Data
(60) Provisional application No. 61/325,654, filed on Apr. 19, 2010.

(51) Int. Cl. G06F 17/50; G06Q 30/00

(52) U.S. Cl. 703/1; 705/26.5

(57) ABSTRACT

A computer based online AutoCAD generation system is a questionnaire based system with dropdown menus for selection of options. The online system is secured with two levels of user authentication to gain access to the drawing system. Backend processing is used for approving the user registration. As the user selects the drop down menus the product parameters are populated based on the user selection. Once the product is selected the user submits for drawing and within a matter of seconds the drawing is shown online with zero client view using Autodesk Freewheel Project with its open source project. The user is given an option for downloading pdf files as well. This system can be used for any manufacturing with few modifications like questions and drawing templates appropriate for a specific product or class of products. In the described embodiment the system is designed for overhead steel rolling doors manufacturing.

### CROSS REFERENCE TO RELATED APPLICATION

This application is related and claims priority of Provisional Patent Application Ser. No. 61/325,654 filed Apr. 19, 2010.

### BACKGROUND OF INVENTION

1. Field of the Invention

The present invention generally relates to product design and manufacturing and, more particularly, to an online system and software application that allows users to create AutoCAD Drawings online based on a simple questionnaire based system to make it easy for the users to create drawings for manufacturing of a product within a given industry.

2. Description of the Prior Art

There are numerous applications for creating drawings based on scripting. In these application scripts have to be manually written or other software needs to be used for scripting separately. Also, in such application variables have to be manually passed to the drawings. All of the software involves a complicated process to create an engineering drawing and extensive software needs to be used. That requires users to learn the software that is used and different users may need to be involved in the process which was made to be simple and integrates all these different software together and makes it simple for anyone with corresponding product knowledge to be able to use the system with ease.

Thus, for example, in U.S. Pat. No. 6,230,066 a system is disclosed for simultaneous manufacturing and product engineering integrated with knowledge networking. However, the method requires the steps of creating a logic modeler through a direct engineer. Creating a logic modeler requires a series of steps that generally requires a high level of skill. Furthermore, the user who requests review of the initial specifications those results in an analysis of the modeler interacts with the analysis in response to such indications to converge on acceptable or improved engineering design functions. The method is particularly useful in using computer assisted engineering designs for rapidly bringing together the collective engineering intellect or knowledge pool of one or more engineering organizations on a specific engineering project. The intention is for consolidating the scientific principles of many disciplines that bear on an engineering project by the direct engineer who is intended to provide alternative solutions and make judgments within shorter time than is currently required.

In U.S. Published Patent Application No. 2003/0115108, a method and system is disclosed for designing and ordering products for manufacturing on-line. The method involves having a customer log on to a network that lists equipment to configure a design. When a customer selects the equipment, a system prompts the customer to enter various parameters and guides the customer through the design. A system automatically generates a drawing based on the customer-selected parameters. The system also provides all necessarily parts, drawings ready for manufacturing without additional information from the customer. Design, specification, and drawings are based on the customer entered parameters automatically generated and sent to the customer over a network or by facsimile. The method involves a customer, after login into the system, to be presented with a display from which the user may select a number of options for performing desired functions. Once such option is for configuring equipment or product design. The user provides a number of predetermined parameters including the type of equipment or product the user is configuring and submits the data to a remote engineering site where a drawing according to the user's submitted data is drafted and e-mailed back to the user. Once the user decides to place an order for the equipment, the user reviews the e-mailed design specification and approves, the user can order the product from manufacturer from the same website or the web page that the user used to configure the product. As taught by the patent, however, a remote user can configure and receive an e-mail of the configured equipment by means of the equipment design server. The server accesses the data stored in the database and the user may order the configured equipment without entering any additional information. However, the configured equipment is submitted by the customer drawings are produced at the back end of the system and e-mailed to the customer. The customer has the option of converting to an “actual order”. The method, however, is not automated because the drawings must be first produced based on the customer's specifications, and the customer only sees the finished product after the drawings have been submitted to him at which time an order can be converted to a purchase order.

In U.S. Pat. No. 7,567,849, a system and method is disclosed for designing and manufacturing engineering objects. This system and method, likewise is typical of many prior art approaches in which the customer deals with sales personnel and/or engineering personnel as intermediaries for the production of estimates, lay out drawings and designs. Typically, after interaction with sales personnel an estimate or a quotation and lay out drawings are produced which in turn are provided to the customer. After the customer approves the estimate and the drawings, an order is places with engineering at which time the product is converted to a final design for manufacturing. The system and method do not provide the customer the option to create drawings online, without such intermediaries, for immediate feedback.

### SUMMARY OF THE INVENTION

Accordingly, it is an object of the present invention to provide a system and automated method for creating drawings online for product manufacturing that does not have the disadvantages of prior art systems and methods.

It is another object of the invention to provide a system and method as in the aforementioned object that is easy to use and allows a customer with minimal design or computer skills to create a given product or class of products without the need to communicate or rely on “backend” personnel.

It is still another object of the invention to provide a system and method as in the previous objects that provides a customer the ability to obtain immediate feedback to facilitate efficient decision making.

It is yet another object of the invention to provide a system and method of the type under the discussion that only requires that a customer answer a series of simple questions for the generation and production of engineering drawings.

The system and method of the present invention provides users with easy application to create drawings for a wide range of potential customers, dealers, engineers and architects. With ease in mind, the system and method can be used by any potential customer requiring minimal skill or knowledge of the software or engineering drawings.

The application of the present invention involves the use of a number of different software applications all of which are integrated but essentially are “invisible” to a potential user. Each software application is essentially stand-alone and operates by itself although it is integrated and interfaces with the other applications as needed. A manufacturer and provider of products (“vendor”) can maintain its customers, dealers, engineers and architects who can easily access and use the system. The system can generate preliminary drawings that can be converted to the approved drawings for manufacturing.

The system basically provides users with easy application to create drawings or customers, dealers, engineers and architects. The application was designed for ease of use in mind. This application has complex architecture involved with different software applications or packages that are integrated. Each piece of software is individual and operates by itself. The pieces of software that forms the system software include the following software used as supporting application. The Main system 1, 2, 6 are custom designed. The rest are third party tools used to automate the process.

1) User Security Access System

This system creates the security Model for the entire application. As these applications create confidential and propriety Drawings only authorized users are allowed to create drawings. The customers, dealers, engineers, architects have to register to gain access to the system. Once the registration is complete the vendor management will enable the application and authorize the company or user. The company or user who will use the system will create drawings and these are created in the backend by the management. This is done to ensure the security and limit access to what they can do. The management is suppose to be notified when an employee leaves the company that the employee belongs to. The management can then deactivate the user. Without being registered no one else is allowed to access the system. This system also allows the vendor to collect personal information about the users of the company like email addresses and first and last names to send emails as pdf drawings. This system can also collect company information for credit approval process and kept confidential.

The system is designed with MS SQL at the backend and asp net at the front end of the application. The database is secured that no outside access is allowed and only restricted inside access is provided to corresponding applications that “talk” to the database.

2) Synthesis Software that Creates a Script and Creates an AutoCAD Drawing in dxf Format.

This Software plays an important role in creating a script file in the drawing engine that creates the drawings for the customers.

3) dxftodwf Utility that Converts the dxf to dwf.

this Utility Takes the Output from Synthesis and Converts it to Online-Based drawing(s).

4) dxftopdf Utility that Converts the dxf to pdf Format

This utility converts the output from Synthesis to pdf format.

The challenge in today's Internet world is that users have different browsers to access the Internet. So the drawing system uses the Zero Client display of drawing concept. This means that the client browses does not need to have any “plug-in” installed to view the drawings. To achieve this Autodesk Freewheel Project is used. Basically the dwf drawings is displayed online using Autodesk Freewheel Project as passing the drawing dwf file as a parameter. This makes the application easily usable to produce online drawings instantly. Then system will also send an email to the customer with the drawings as pdf or dxf.

This system is built based on the concept to make the entire application web based.

5) Backend Admin System

The Back End Administration System is where the company users have the ability to administer the system. This includes creating and modifying questions, answers or options maintenance and ability to view any drawing that has been generated, reporting functionality and providing security access and system maintenance.

6) The User Security Access Maintenance

This allows the management to maintain their customers, dealers, engineers, and architects that use the system. Here they have the option to control the access of logins and users. This is important since without access no one can access the system at all.

### Reporting:

The Management can view the drawings that are generated. Also every drawing is tracked by their user login. Management can view drawings per user based how many drawings are generated for future analysis purpose.

At the back end of the system the internal company users are allowed access to the drawing files so that they can take the drawings and edit those to customer specific needs. There are drawings that need engineer's approval so that's why the system allows the drawings to be edited and get signed by the engineers. These drawings are on customer request basis only.

So the system can generate a preliminary drawing and then be converted to approve drawings in construction or other manufacturing industry.

### BRIEF DESCRIPTION OF THE DRAWINGS

Those skilled in the art will appreciate the improvements and advantages that derive from the present invention upon reading the following detailed description, claims, and drawings, in which:

FIG. 1 is a block diagram of the system for creating drawings online for product manufacturing in accordance with the invention;

FIGS. 2a-2c represent the overall flow chart in accordance with the invention;

FIG. 3 is a flow diagram illustrating the program logic of providing user's security; and

FIG. 4 is a flow diagram illustrating the program logic of the back end administration process.

### DESCRIPTION OF PREFERRED EMBODIMENTS

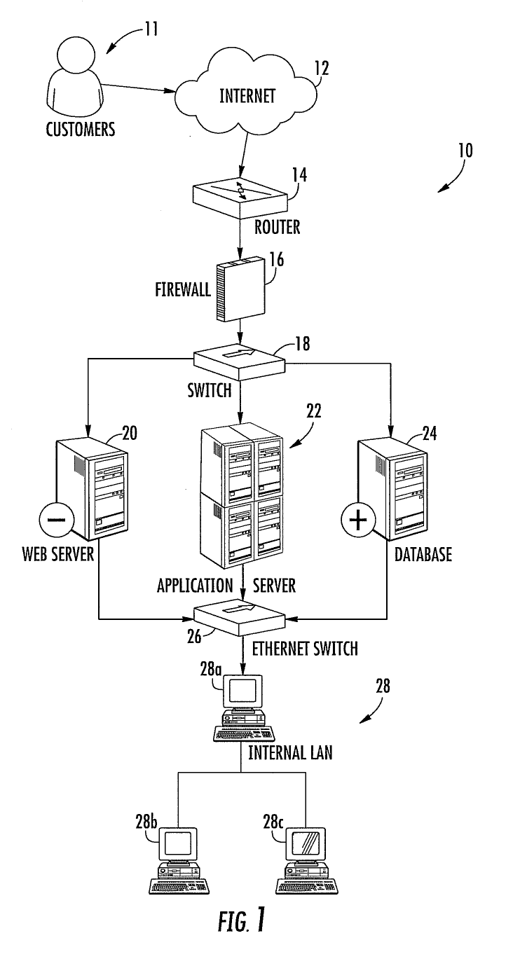

Referring to the Figures in which identical or similar parts would be designated by the same reference numerals throughout, and first referring to FIG. 1, the overall system configuration 10 is generally designated by the reference numeral 10.

The system 10 involves customers or potential customers 11 creating product drawings online, as will be more fully described. To do that, the customers or potential customers 11 log in the system 10 by means of the Internet 12. At a vendor site a router 14 routs the incoming data through a firewall 16 to a switch 18. A firewall 16 secures the system network, while the switch 18 connects a web server 20, an application server 22 and database server 24, the outputs of which are directed through an Ethernet switch 26 to the local area network (LAN) 28 of the vendor or manufacturer consisting of a plurality of computer terminals 28a-28c.

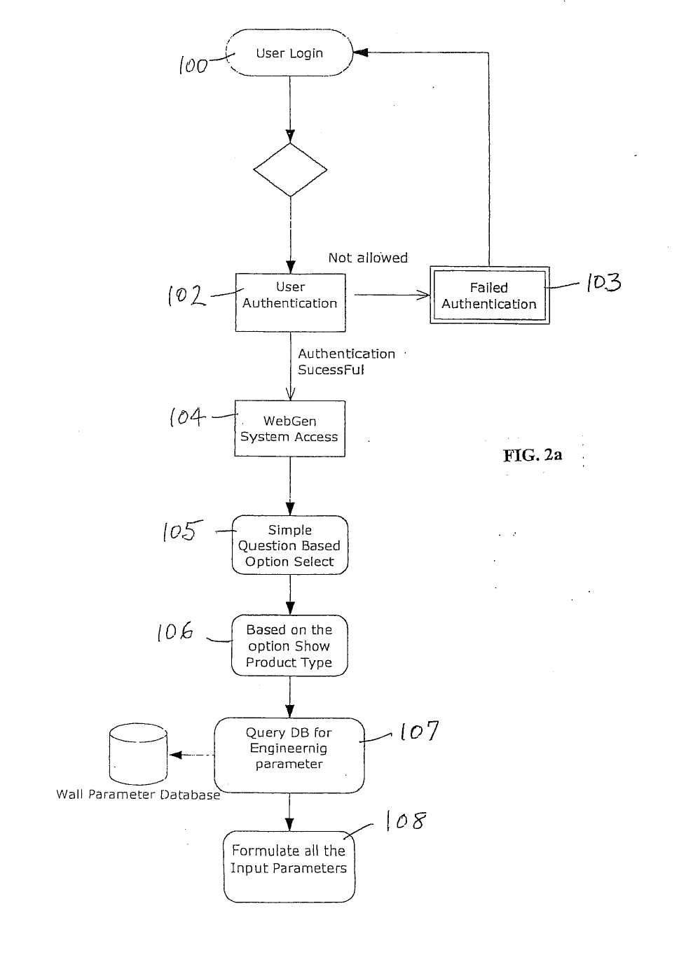

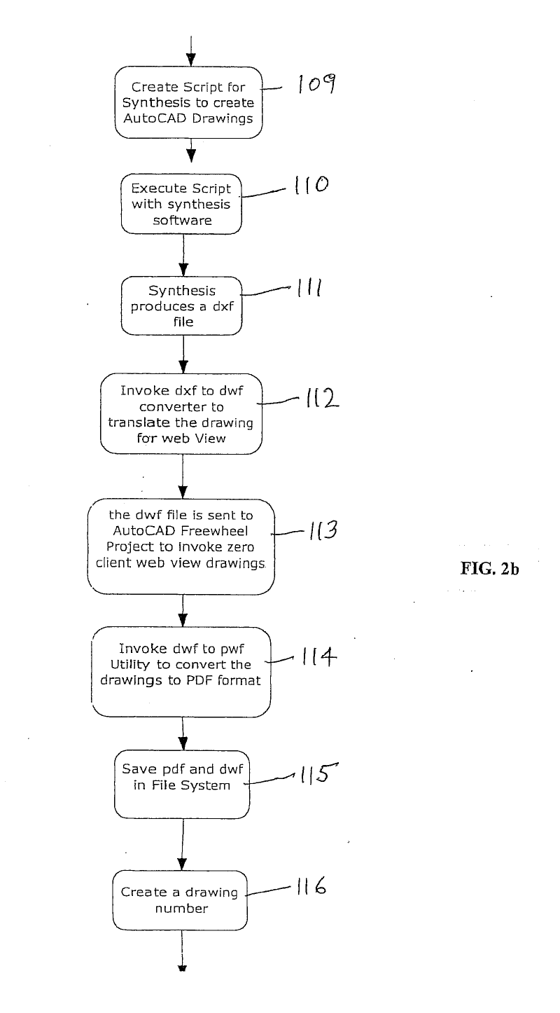

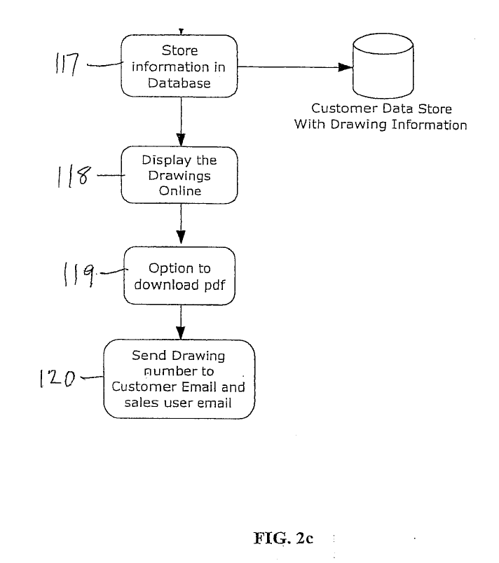

The system software, to be more fully described in connection with the flow charts illustrated in FIGS. 2a-4, a number of the software applications including the following.

The system software, therefore, includes the aforementioned applications, and as indicated, third party utilities are used as supporting applications. The user security access system, the questionnaire based Product Selection System and the utility are not off the-shelf commercial applications, and these are explained more fully in the description of the follows.

The User Security Access System Software Application.

As this application creates confidential and proprietary drawings, only authorized users are permitted to access the system and create drawings. Thus, customers, dealers, engineers, architects, etc. must be registered to gain access to the system software, and the vendor management authorizes the use of the system software. Once the users of the systems have been identified, approved as authorized users, they are permitted to log in. This is done to ensure secure access and the level of access that users are given. The management or the “backend” vendor can be notified when an employee leaves a company of a potential customer so that such employee may be deactivated and no longer provided with access to the system software. Without being registered no one else is allowed to access the system software. The system will also allow personal information to be collected about the users of the company or a potential user, such as e-mail addresses, first and last names, etc. so that e-mails may be sent as PDF drawings once these have been created and completed. The system will also collect company's information for credit approval process and such information is, of course, kept confidential.

The Synthesis software, a commercial application, executes the script created by the application and creates an AutoCAD drawings in dxf format. Synthesis resides on the web server 20 and plays an important role in executing a script file in the drawing engine that creates the drawings for the customers. This tool creates or assembles the templates to finish or complete the drawings.

The dxf-to-dwf utility converts the dxf to dwf formats and is a utility that takes the output from the Synthesis application and converts it to online-based drawings. This dxf-to-dwf software converts the dxf files to dwf web format. An example of such an application tool is AUTODWG.com. However, numerous other conversion tools are available and may be used as well.

The dxf-to-pdf utility converts the dxf to pdf format. This utility converts the output from Synthesis and converts it to a pdf format for customer downloads. One example of such a conversion tool is made commercially available by VERYPDF.inc. Again, numerous others such applications exist and may be used.

An Internet information server is resident to an IIS application. The system is designed to use Microsoft SQL at the backend and ASP net at the front end application.

AutoCAD dxf is a data file format between the AutoCAD and other programs. It was originally introduced as part of AutoCAD to provide exact representation of data in the AutoCAD native format, dwg (drawing).

Design web format (dwf) file format was developed for efficient distribution of rich design data for anyone who needs to view or print design files. Such files tend to be highly compressed from multiple AutoCAD drawings in a single dwf file.

Internet information services (IIS) was formally called Internet information server application instead of feature extension modules created and used with Microsoft Windows. The IIS application is build on a modular architecture. Modules also called extensions that can be added or removed individually and provide individual features that serve the users to process requests and include modules, security modules, content modules, compression modules, catching modules and diagnostic modules. The software provides numerous security features.

The SQL is a software database computer language designed for managing data in relational database management systems, including data query and update, data modification and data access control. However, while SQL has been become the most widely used language for relational databases, other database applications can be used, such as Oracle or other comparable commercially available applications.

The Questionnaires based Product Selection System application is at the front end of the system for the users, customers, architects and engineers. Once the user is authenticated he or she is given access to the drawing application. The screen shows which options can be selected. Based on the selection suitable products are displayed. This gives the user the option to select what is needed for a given requirement, to avoid confusion of what product will fit a given need. This system collects information about the product's specification and then it is sent to the Drawing Engine.

This system also has a backend application. This is where the internal company users can maintain questions and options to these questions. The complete system is allowed to edit, add new, update questions and as well the answers or options. A Mapping system is provided that maps each question to answers or options. The system relies on use of a simple questionnaire format. The system is designed in such a way that you can apply any answers to any questions can be applied. This is many to one relationship based.

Each answer is mapped to the product type available at the back end to an artificial intelligence system. This system takes all the options and does intelligence assessment of what products will be the best fit for given options, which will be selected and then displayed in the front end. This system updates the products as the user chooses the answers or options.

Finally once the user selects all the answers or options as well as the product type this information is then passed onto the Drawing Engine for further processing.

When the product is involved in construction, such as rolling steel doors, there are specific options that need to be specified like engineering variables like overall guide width, overall guide height and some others. This system is a standalone system that generates for all available sizes of overhead doors that can be manufactured by a vendor. This is then uploaded into the database using a tool that is custom developed to populate the variables in the database. Once the variables are populated this is used by the Drawing Engine to pass these variables to drawings.

Lotus Engineering application can be used for rolling steel door manufacturing. The overall system integrates this to produce AutoCAD drawings for rolling steel door manufacturing. This system can you modified to other applicable industries to produce drawings for any product or class of products by customizing the questions, options and available parameters.

The elements of the software that forms the system software are:

### 1) User Security Access System;

2) Questionnaire based on a Product Selection System;
3) Lotus Engineering application that produces engineering parameters for the product design, such as steel rolling doors to select parameters as wall construction, size needed, nature of guides such as e-mount, z-mount and pack out angle;
4) Synthesis Software that executes the script produced by the Product Selection System and create an AutoCAD Drawing in dxf format;
5) A dxf-to-dwf utility that converts the dxf to dwf formats;
6) A dxf-to-pdf utility that converts the dxf to pdf formats;

### 7) A Drawing Engine; and

8) A backend Admin system.

A primary part of the software application is the Drawing Engine. This is where everything is integrated to create a complete drawing. The system takes the user's answers or options with the product type and obtains the variables for engineering from the database and creates a script that can be fed into the Synthesis system to process the drawings. The system also checks for the AutoCAD templates that are used for the product, in the current example an overhead rolling steel door.

Creating AutoCAD involves the vendor company or business creating their own templates in AutoCAD for their products. For example, at Alpine Overhead Doors rolling steel doors for commercial purposes are produced and it has templates created based on its own line of products with dynamic variables. Dynamic variables allow the needed variables to be incorporated in to the drawings as needed. The templates can have the company logo and/or product logo. Also the templates are for engineer drawings for the products. The templates can also be layered so that the drawing system can pick and choose which templates to pick and layer them to get a complete drawing.

Once the Drawing system queries all the variables that the user inputs it creates the script file with all the necessary variables, Templates, name, P.O. number, Email address, width, height, wind load option all in the script file. This script file is processed using Synthesis to generate a dxf file which is the AutoCAD format Drawing. Now that the drawing is ready the utilities are used to convert to different formats for easy display.

The dxftodwf utility is used to generate dwf format of the drawing, while

The dxtopdf utility is used to generate pdf file.

Referring to FIGS. 2a-2c, the following process or method includes steps used to implement the objectives of the system:

101) User Login Screen. This is the entry point for the system that allows users to authenticate to gain access

102) User Authentication: This is the process that authenticated the users in User security access control system. Only authorized users are allowed to access the system

103) Failed Authentication: This process tells the user why the authentication has failed and directs the user to either register or to check the username and password.

104) System access: This process once the user is authenticated redirects him to WebGEN drawing system.

105) Simple Question based option select: This process allows the user to select the width, height, wind load option, Email address, project name, P.O. number and shows the questions and answers or options to select from.

106) Based on the Option Show Product Type: Based on the selection the system shows the corresponding products available to select from.

107) Query database for Engineering parameters: This process allows the Drawing Engine to select the corresponding engineering variables from the database and retrieve the variables to create the script file for the drawings

108) Formulate all the input parameters: This process takes the variables from above step 107 and also the templates that are needed and creates a script file formatted for Synthesis to execute.

109) Create Script for Synthesis to create AutoCAD Drawings: This process actually creates the file. The templates are layered corresponding. The Dynamic variables are assigned. The necessary Synthesis executables are called.

110) Execute script with Synthesis: This process executes the scripts generated from the system.

111) Synthesis produces a DXF File: The output from step 110 creates a DXF file which is the AutoCAD file with drawings with all the variables and templates consolidated.

112) Invoke the dxf to dwf converter to translate the drawing for Web View: This process convert the drawing to a Web-based viewable format using utilities.

113) The dwf file is sent to AutoCAD Freewheel Project to invoke zero client Web view drawing:

This process allows the drawings to parse through Autodesk Freewheel Project to help the customers view their drawing online with zero client installation. This allows the drawing to be viewed in any browser without any restrictions.

114) Invoke the dwf to pdf Utility to convert the drawings to PDF format: This process convert the AutoCAD DWF Drawing format to a user readable Portable Document File (pdf).

115) Save the pdf and dwf in the File System: This process allows the generated drawing files to be saved in the file system for further processing.

116) Create a drawing number: This process creates a drawing number for future reference. This number allows the back end administrator to view the drawing and edit the drawing(s) when a customer needs modifications.

117) Store information in Database: this process stores all the collected data in the database for further processing including creation of reports and data mining.

118) Display the Drawings Online: This process display the drawings online for the customer or user who requested the drawings.

119) Option to download pdf: an option is given to the user to download in the pdf format if desired.

120) Send Drawing number to Customer Email and sales user email: A confirmation email is sent to the customer who requested the drawings as well to internal sales personnel for lead purposes with the drawing number.

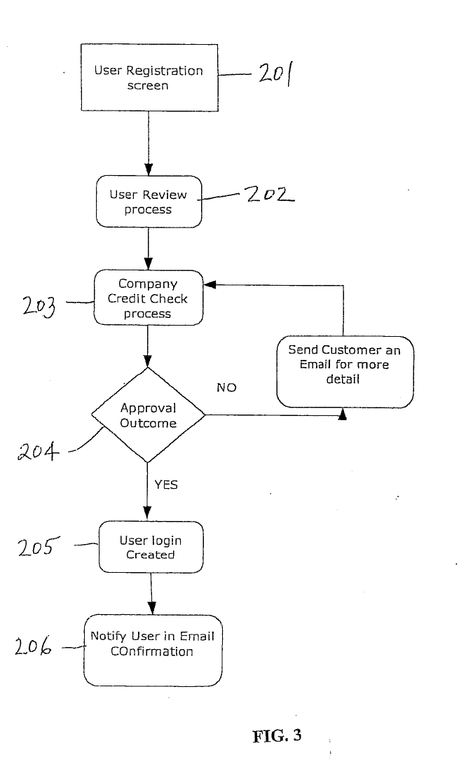

Referring to FIG. 3 a block diagram of user security process includes the following steps:

201) User Registration Screen. This is where the users register their company and users gain access to the software application.

202) User Review process: This is where the user's registrations are reviewed by the management to determine the authentication and determine whether the user(s) are allowed or disallowed.

203) Company Credit Check: This is where the company credit review is done by the management. The reference provided is called to verify the integrity of the company

204) Approval Outcome: If the review process is successful then the process proceeds to step 205. If the review is unsuccessful then an email is sent to the customer asking for more information or reject the customer or user.

205) User Login created: This is where the company login and company specific user logins are created to access the system.

206) Notify Customer with Email Confirmation: Notify the customer with successful authentication and confirmation email is sent with login information for the customer or user.

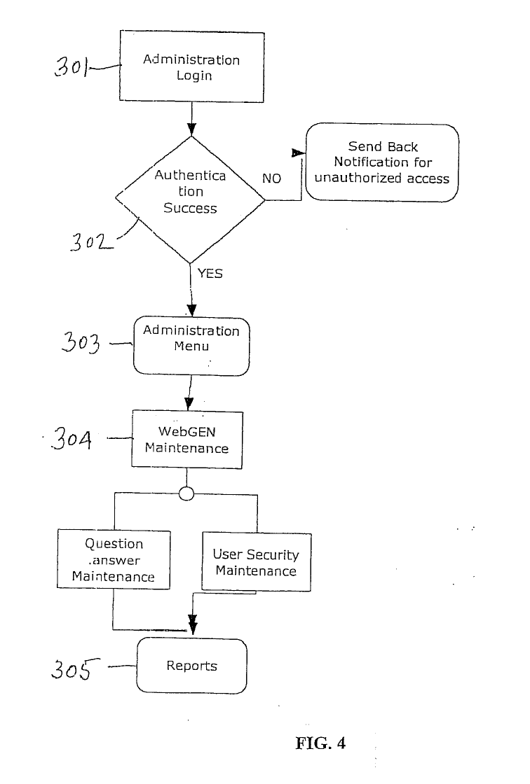

Referring to FIG. 4a block diagram of administration process—back end includes the following steps:

301) Administration Login: The back end admin login is protected with a username and password. Without proper authentication no access is allowed to the Back end.

302) Authentication Success: this is the process of authenticating the user. If unsuccessful then the user is redirected to the login screen. If success then the process proceeds to step 303.

303) Administration Menu: This is where the user has the option to perform back end user maintenance, question and answer maintenance, user security access control maintenance and reporting.

304) Question, answer maintenance and user security access control maintenance: This is the maintenance screen option to add, edit, update and delete questions, answers and users who have access to the system. This is also where questions and answers are mapped to the mapping system.

305) Reports: This step is where management can view the reports on the performance of the drawings such as how many drawings are created, and who created the drawings.

In a specific example the system and method is used to create designs and drawings for overhead rolling steel doors.

The Web Generation Drawing Project includes:

1) Questionnaire based drawing system;

2) Detailed Product Configurator with drawing for engineers and architects.

1) Questionnaire-based Drawing System:

Introduction:

It is a unique system that allows users to select their answers for a fixed set of questions. Based on their selection the system will give suggestions of the product type(s) available. Once the type in selected with the questions a script file is created and executed in the backend to create AutoCAD drawing based on existing templates available.

System Design:

Functionality:

The system is designed for end users to select a set of questions that will allow the vendor to find the requirements and based on that the system provides suggestions which allows automated AutoCAD drawing to be generated at the backend.

System Requirements can include:

Opening width of the Door

Opening length of the Door

Customer First Name

Customer Last Name

Customer Company Name

Customer Email address (To send drawing as email)

Wind load Selection Option is YES/No

If YES then display wind load values.

Questions display.

Suggestions Display based on the question selection.

Ajax Implementation: as they select the questions suggestions are updated through from database dynamically.

Validate the above said values.

Once the validation is passed the values are passed to the backend and an AutoCAD script is generated from asp. The script is given name with time and date as filename and placed in the folder W:\Scripts.

The Backend script Functionality

The scripts takes the values from the web site and then process it and writes a script file that can be executed in AutoCAD. The script is given .scr extension so that the autocad can run and also formatted to run in autocad. The scripts loads all the templates necessary for the drawing based on the question selection. Once the script is run it creates a pdf plot with same name as .scr file and saves it with .pdf extension. This file will be ready to email to a customer as an attachment. The backend script validates the wall parameters from database lookup and based on values creates a script file that is unique to the selection.

Certain necessary aspects of the door design:

What type of operations

What Coiled side

What Materials used for the door

Length and width of the door

Based on these parameters a door drawing is created. This is a rough drawing for estimation purpose only.

Technical Details:

Active server pages

MS SQL 2008

Sharepoint Integration

Autocad

Script File

The system is a client server architecture. The Database design is based on the functionality. The system has two phases.

Phase 1—Front end System

Phase 2—Back end system or the administrative Interface.

Phase 1: Front End System:

This is where the end user inputs the information and selects the questions, answer and selects a type of door. Also the asp scripts create an AutoCAD script file.

Phase 2: Back End Admin System:

This is where the administrators can

ADD/Update Questions

ADD/Update Product Type

Link Product to Questions answer

Run the AutoCAD script file using the Synthesis software

Send email to customer.

The system also captures all the estimates and saves them in the database for future reference.

A table is designed in the database where height and width of the doors are maintained.

A table is designed in the database for referencing wall parameters that shows on the drawings. These values are dumped as a text file from LOTUS engineering application. The data is IMPORTED into the database in the back end.

The Main question table is multi level category table which can be saved for future use.

The Product type table is by itself with product specific information.

There is the product question link table which has link in between them.

The entire back end is integrated in SharePoint.

Go to SharePoint home http://asp001/.

On the main menu there is an option ProdConf click that Prodconf will show all the menu items.

The SharePoint integration makes it easier because everything is in one location.

Backend Activities:

A script is generated based on the front end Inputs.

This is a spec file for a software called Synthesis.

Synthesis then takes the file and then runs to create the dxf file.

The dxf file is then converted to dwf (web based file format).

AutoDWG software is used to convert the drawings to dwf format.

This dwf drawings is then passed to Autocad Freewheel Project to be display on the web site seamlessly.

An email is automatically sent to customer with drawing(s) attached.

Customer gets to see the drawing online on the confirmation page.

The Freewheel Project allows customers to print and zoom the drawings.

2) Detailed Product Configurator with Drawings for Engineers and Architects.

Functionality:

Introduction:

This system will allow architects and Engineers to design their door by selecting the engineering parameters like materials, curtain, pipe etc. This system will generate more complicated drawings with actual values. This system will also create a text file that can be inputted into Lotus Engineering application to do the in depth calculation and allows the creation of the work orders. This will also integrate into EPICOR to tag the drawings for each order.

This is an artificial Intelligent design system to design a Rolling Doors.

Possible business requirements specifications:

Product Configurator:

Display the Product Specifications

Collect information of customer

Collect information regarding door parameter.

Customer Information

Customer name

Customer Company Name

Customer email

Door Information:

Door width

Door height

Wind Load YES/NO

If YES then display option to select from.

Display Parameters that govern the making of Door.

Type of curtain

Type of material for curtain

Size of curtain

Hood details

Pipe details

Operation type

From Coil Side

Style of Door

Fire/WIND/Storm/Hurricane etc

Wind Load

Gauge details for materials

Flexible to add more parameters

Engineering parameters (criteria)

Size Limitation: Based on size certain doors cannot be used.

The parameters change based on the size of doors.

Certain parameters are not allowed for certain sizes.

Incorporate Pricing of the doors

Based on all these a script is generated in .scr extension to run in AutoCAD. Here the operation is made real time so that drawing is shown to customer on their web screen at the time parameter is selected.

This system will also give an option to create a quote for the product in EPICOR.

Intern will be pushed as orders. The system will also write a text file that will be pulled in the LOTUS ENGINEERING application where detailed calculations are made and imported into EPICOR for production.

Technical Details:

This will be Active server pages based.

AJAX

.NET platform

MSSQL 2008 as Back end Database

Synthesis for autocad drawing generated for web display.

Text file for lotus spreadsheet.

Database Details:

Category Table

Sub category table (links the category table)

Product type table

Product and category/sub category link table

Product Feature table

Product specifications table

Wall parameters tables

SQL Functions for suggestions display.

This project will Have:

Front End Design

Back End Admin Design

Front End Design:

This is where the architects and engineers select the design parameters to design the door. Then it gets inputted to the drawing generation system to create drawings and then displayed.

An option is given to customers to have a generated quote in the ERP EPICOR system.

Every inquiry on this system is stored in the database to collect data for further business intelligence.

Back End Admin System:

ADD/Update/delete category

ADD/Update/Delete sub category

ADD/Update/Delete cat/sub cat product link

ADD/Update/Delete Feature

ADD/Update/Delete Specifications

ADD/Update/Delete Product Type

The system also captures all the data for future business intelligence purpose.

The whole admin interface is integrated in the SharePoint.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for creating drawings online for product manufacturing comprising:
a user computer terminal;
user access means for providing said user computer terminal access to the Internet;
a service provider site remote from said user computer terminal;
provider access means for providing said service provider site access to the Internet;
said service provider site including at least one server provided with a software application for enabling a user, using said user computer terminal, to make product and/or specification selections online using an interactive interface for product selection and/or specification and for automatically and substantially contemporaneously creating product and/or manufacturing drawings for online delivery to the user.

2. (canceled)

3. (canceled)

4. A system as defined in claim 1, wherein said service provider site includes a web server, an application server and a database server.

5. A system as defined in claim 1, wherein said access means includes a firewall.

6. A system as defined in claim 4, wherein said web server is programmed with synthesis software for providing script to implement a drawing engine.

7. A system as defined in claim 1, wherein said system includes a front end for providing access security and interactive product selection interface with user.

8. A system as defined in claim 1, wherein said system includes a back end controlling access security and for creating and modifying the user interface for determining questions and/or options for selection by a user of product(s) and/or specifications.

9. A method of creating drawings online for product manufacturing comprising the steps of:
providing a user computer terminal;
providing said user computer terminal access to the Internet;
providing a service provider site remote from the user computer terminal;
providing said service provider site access to the Internet;
enabling a user to make product and specification selections online with said service provider site using an interactive interface for product selection and/or specification;
automatically generating product and/or manufacturing drawings at said service provider site; and
delivering the product and/or manufacturing drawing online to said user computer terminal.

10. A method as defined in claim 9, further comprising the step of authenticating a user prior to enabling user to make product and specifications online.

11. A method as defined in claim 10, wherein said enabling step comprises presenting to the user question-based options for selecting product and/or product specifications.

12. A method as defined in claim 11, further comprising displaying on said computer terminal product type and/or specifications reflecting input by a user to questions or options presented.

13. A method as defined in claim 11, further comprising the step of querying a database containing data reflecting products and/or engineering parameters reflecting selections and/or input by a user to questions or options presented.

14. A method as defined in claim 13, wherein selected engineering parameters are used to generate script for generating auto CAD drawings.

15. A method as defined in claim 14, wherein the execution of the script is accomplished with synthesis software.

16. A method as defined in claim 15, wherein synthesis software is used to create a dxf file.

17. A method as defined in claim 16, further comprising the step of converting the dxf file to translate the dxf file to a dwf file to enable the drawings to be viewable on the web on the user's terminal.

18. A method as defined in claim 17, further comprising the step of converting the dwf file to zero client web view drawings.

19. A method as defined in claim 18, wherein the dwf file conversion is performed by auto CAD Freewheel Project software.

20. A method as defined in claim 17, further converting the dwf file to PDF format.

21. A method as defined in claim 20, wherein conversion to PDF format is performed by means of a dwf to pdf conversion utility, and further saving at least one of said pdf and dwf files.

22. A method as defined in claim 21, further comprising the step of sending drawing to user by e-mail.

23. A method as defined in claim 11, further comprising using artificial intelligence (AI) for selecting the best options available from stored options to correspond to user selected product and/or product specifications prior to automatically generating drawings.

24. In a system for creating drawings online for product manufacturing and/or specification by using at least one user computer terminal and a remote service provider site including a server for selective interaction with at least one of said user terminals over the Internet, a software application on said service provider server for providing security for limiting only authorized users access to said server;
providing an interactive method for product and/or specification selection by the user;
producing engineering parameters for the product design created through the interaction with the remote user;
synthesizing and create auto CAD drawings; and
transmitting the drawings to the user.
